(19) United States
(12) Patent Application Publication
(10) Pub. No.: US 2006/0256914 A1
(43) Pub. Date: Nov. 16, 2006

(54) Non-intrusive container inspection system using forward-scattered radiation

(76) Inventors: Matthew B. Might, Atlanta, GA (US); Mark A. Ferderer, Buford, GA (US); Gary F. Bowser, Auburn, IN (US)

Correspondence Address: COURSEY & COURSEY, P.C., 1930 NORTH DRUID HILLS ROAD, SUITE 150, ATLANTA, GA, 30319, US

(21) Appl. No.: 11/273,585

(22) Filed: Nov. 14, 2005

Related U.S. Application Data
(60) Provisional application No. 60/627,456, filed on Nov. 12, 2004.

(51) Int. Cl. G01N 23/04

(52) U.S. Cl. 378/57

(57) ABSTRACT

A non-intrusive container inspection system, including apparatuses and methods, for non-intrusively scanning and inspecting containers employed to transport items therewithin that utilizes forward-scattered bremsstrahlung, or x-rays, for generating multi-plane images of items present within the containers and for distinguishing between multiple materials present in such items. The system is adapted to direct a pulsed bremsstrahlung, or x-ray, beam having multiple spectra in a substantially single direction at a container being scanned and to produce data that corresponds to portions of the beam that either pass through items within the container without being scattered or that are forward-scattered by items within the container. The system employs a detector array having sections specially configured and oriented to receive and produce data corresponding to the non-scattered and forward-scattered portions of the beam.

### CROSS REFERENCE TO RELATED APPLICATION

This application claims the benefit of priority to U.S. provisional patent application Ser. No. 60/627,456 entitled “Systems and Methods for Non-Intrusively Inspecting Containers Using Forward-Scattered Radiation” and filed on Nov. 12, 2004, now pending.

### FIELD OF THE INVENTION

The present invention relates, generally, to the field of non-intrusive inspection systems and methods and, more specifically, to non-intrusive container inspection systems and methods for inspecting containers employed, generally, in or with the transportation industry.

### BACKGROUND OF THE INVENTION

Today, only a small percentage of the containers that are employed by the transportation industry to transport goods in commerce are examined or inspected for contraband when they enter a country through a port of entry such as a border crossing, an airport, a seaport, or a rail port. For those containers that are actually inspected, such inspection is often conducted by opening the containers and having inspectors visually and/or manually inspect items within the containers. Alternatively, specially trained dogs may sometimes be employed to inspect and, potentially, detect items such as explosives or drugs present within containers. Such inspection practices are manpower intensive and take a substantial amount of time per container, thereby making it cost prohibitive to inspect a high percentage of the number of such containers that enter a country.

Due to recent terrorist activities and because such a small percentage of the containers are inspected, there is heightened concerned among citizens and government officials alike that terrorists may place nuclear bombs, “dirty” bombs, biological or chemical agents, or other weapons of mass destruction in such containers in order to smuggle them into a country for subsequent use in a terrorist attack against the country's citizenry. As a consequence, a number of vendors are developing non-intrusive inspection systems for such containers. Some of the vendors have based their systems on technology utilized in airport baggage scanning systems. Unfortunately, such non-intrusive inspection systems suffer from many difficulties, including that many of the systems do not produce three-dimensional views of the items present within the containers. Also, many of the systems do not provide for the discrimination or identification of materials found in the items present within the containers, thereby making the detection of explosives, nuclear materials, and, for the most part, weapons of mass destruction virtually impossible.

Other vendors, using different approaches, are attempting to develop non-intrusive inspection systems that produce three-dimensional images of the items present within the containers and/or that provide for the discrimination or identification of materials present in such items. However, such non-intrusive inspection systems may require the exposure of containers to multiple beams of bremsstrahlung (e.g., x-rays), with the beams being directed at the containers in multiple directions in order to collect data representative of the items present in such containers in multiple planes for the generation of three-dimensional images. Further, to discriminate between and/or identify the materials present in the items, such non-intrusive inspection systems may utilize multiple beams of bremsstrahlung having different spectra. Such non-intrusive inspection systems may be expensive and difficult to build, operate, and maintain as they may employ multiple charged particle accelerators (i.e., with their respective control and cooling systems) to produce multiple beams of charged particles having different energy levels and may employ multiple conversion targets and collimators to generate corresponding multiple beams of bremsstrahlung having different spectra from the multiple beams of charged particles. Additionally, such non-intrusive inspection systems may require the use of various movable filters, beam splitters, and turning magnets that may be prone to operational difficulties.

Therefore, there exists in the industry, a need for single-beam non-intrusive container inspection system that produces multi-plane images of items present in containers and discriminates between materials present in such items, and that addresses the above described and other problems, difficulties, and/or shortcomings of current or contemplated systems.

### SUMMARY OF THE INVENTION

Broadly described, the present invention comprises a non-intrusive container inspection system, including apparatuses and methods, for non-intrusively scanning and inspecting containers employed to transport items therewithin. More specifically, the present invention comprises a non-intrusive container inspection system, including apparatuses and methods, which utilizes forward-scattered bremsstrahlung, or x-rays, for generating multi-plane images of items present within the containers and for distinguishing between multiple materials present in such items.

In accordance with the exemplary embodiments of the present invention, the non-intrusive container inspection system comprises an accelerator subsystem having a charged particle accelerator for generating a pulsed beam of accelerated electrons having pulses of accelerated electrons with multiple energy levels that subsequently produces a pulsed bremsstrahlung, or x-ray, beam having multiple spectra. The multiple spectra correspond respectively to the pulses of accelerated electrons with multiple energy levels. The non-intrusive container inspection system also comprises a detector subsystem having a plurality of sections of detectors that are adapted to receive portions of the pulsed bremsstrahlung, or x-ray, beam that pass through a container moved relative to such beam during scanning and inspection thereof. Certain sections of detectors of the detector subsystem receive portions of the pulsed bremsstrahlung, or x-ray, beam that are scattered or redirected by items present within the container. The detector array produces data representative of all received portions of the beam, including data representative of the beam's scattered or redirected portions.

The non-intrusive container inspection system additionally comprises, according to the exemplary embodiments, a controller for controlling the operation of the charged particle accelerator and for collecting data from the detector subsystem that it correlates with the pulses of the bremsstrahlung, or x-ray, beam. As appropriate, the controller also correlates collected data with (i) the planes in which the non-scattered portions of the beam lie and (ii) the planes in which the scattered or redirected portions of the beam lie. Further, the non-intrusive container inspection system comprises an imaging and material discrimination subsystem that is adapted to receive collected and correlated data from the controller and to produce multi-plane images of the items present in, or contents of, the scanned container using such data and voxel rendering. The imaging and material discrimination subsystem is also adapted to use such data to calculate volumes, densities, and effective Z-numbers for the items present in, or contents of, the scanned container and to identify and discriminate materials thereof.

Advantageously, the non-intrusive container inspection system of the present invention utilizes pulses of bremsstrahlung, or x-rays, having multiple spectra to produce and collect data related to items present in a container being scanned or inspected. By virtue of the use of multiple spectra, the non-intrusive container inspection system can utilize the collected data to compute effective Z-numbers for the items present in a container and can distinguish between the materials of such items, whereas a system employing only single spectra cannot. Also, because the non-intrusive container inspection system utilizes a single accelerator subsystem and a single charged particle accelerator in the exemplary embodiments herein, the costs associated with the system may be reduced as compared to other container inspection systems that employ multiple accelerator subsystems and/or multiple charged particle accelerators.

Perhaps more advantageously, the non-intrusive container inspection system of the present invention employs a pulsed bremsstrahlung, or x-ray, beam directed in a single direction at a container being scanned and collects data that corresponds to portions of the pulsed bremsstrahlung, or x-ray, beam that either (i) pass through items within the container without being scattered or (ii) are forward-scattered and redirected by items within the container. Thus, the system collects data corresponding not only to planes that pass through the container and the items therein substantially perpendicular to the direction of travel of the container during scanning, but also to planes that are at angles relative to the direction of travel of the container during scanning using a pulsed bremsstrahlung, or x-ray, beam directed at the container in a single direction. Through the collection and use of data corresponding to portions of the pulsed bremsstrahlung, or x-ray, beam that are scattered forward by items present in the container in addition to portions of the pulsed bremsstrahlung, or x-ray, beam that are not scattered by items present in the container, the non-intrusive container inspection system produces improved multi-plane images of a container's contents and more accurate identification and discrimination of the materials of such contents than other systems that do not collect or make use of data representative of the forward-scattered portions of a pulsed bremsstrahlung, or x-ray, beam. Further, as a consequence of the system's use of data corresponding to the forward-scattered portions of the pulsed bremsstrahlung, or x-ray, beam, the non-intrusive container inspection system makes it more difficult to pre-arrange the positions of multiple items within the container in order to “hide”, render undetectable, or indistinguishable from other items, a particular item within the container containing potentially hazardous or dangerous materials, elements, or substances.

Other advantages and benefits of the present invention will become apparent upon reading and understanding the present specification when taken in conjunction with the appended drawings.

### BRIEF DESCRIPTION OF THE DRAWINGS

FIG. 1 displays a top plan, schematic view of a non-intrusive container inspection system for inspecting the contents of a container in accordance with a first exemplary embodiment of the present invention.

FIG. 2 displays a side, elevational, schematic view of the non-intrusive container inspection system of FIG. 1.

FIG. 3 displays a front, perspective, schematic view of a detector array of the non-intrusive container inspection system of FIG. 1.

FIG. 4 displays a pictorial timing diagram of a pulsed beam of accelerated electrons having multiple energy levels in accordance with the first exemplary embodiment of the present invention.

FIG. 5 displays a top plan, schematic view of the detector array of the non-intrusive container inspection system of FIG. 1.

FIG. 6 displays a front, perspective, pictorial view of a plurality of voxels employed, in accordance with the exemplary embodiments of the present invention, to model a container and its contents for the display thereof.

FIG. 7 displays a top plan, pictorial view of a single plane of voxels of FIG. 6 illustrating scaled values of transparencies for some of the voxels.

FIG. 8 displays a top plan, pictorial view of the single plane of voxels of FIG. 7 in which some of the voxels have been visually rendered using the respective scaled values of transparencies.

FIG. 9 displays a top plan, schematic view of a detector array of a non-intrusive container inspection system in accordance with a second exemplary embodiment.

### DETAILED DESCRIPTION OF THE INVENTION

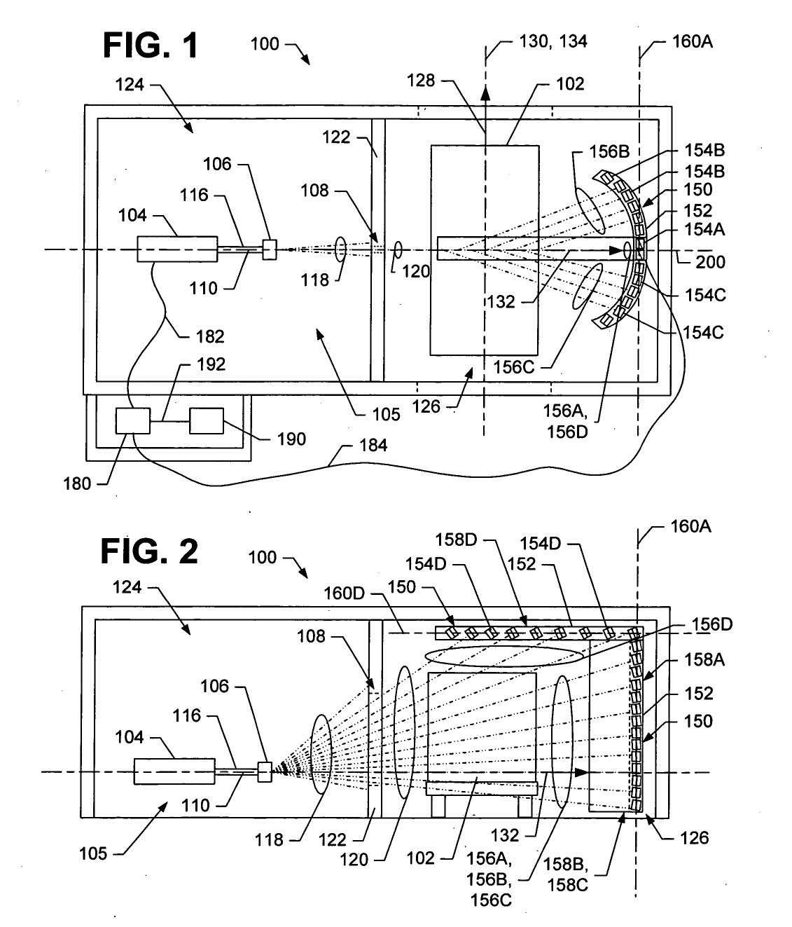

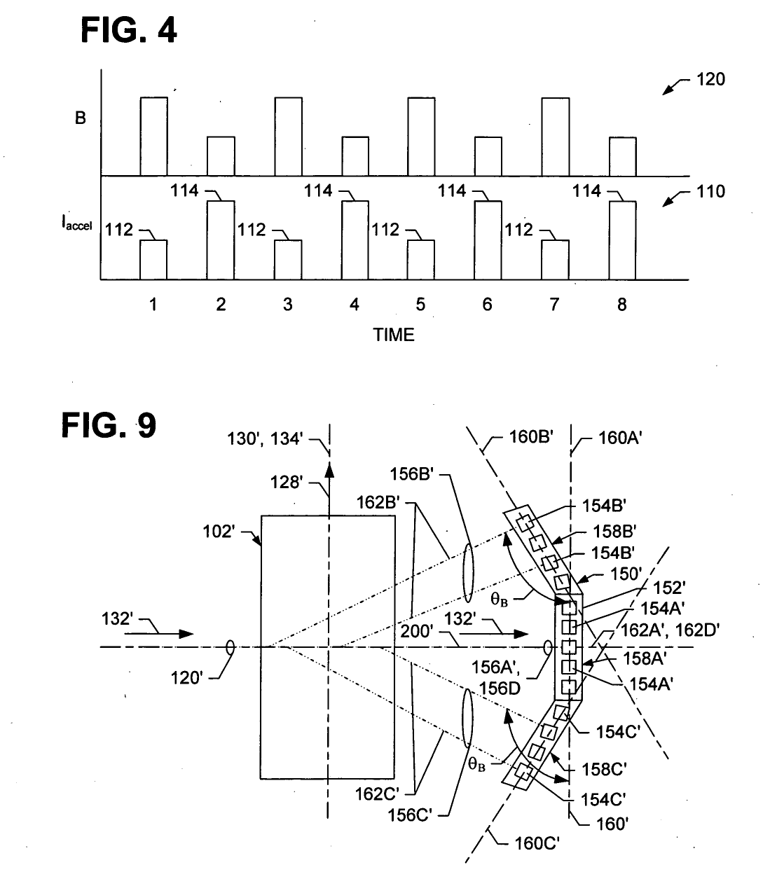

Referring now to the drawings in which like numerals represent like elements or steps throughout the several views, FIG. 1 displays a top plan, schematic view of a non-intrusive container inspection system 100, according to a first exemplary embodiment of the present invention, for inspecting the contents of, or items present in, a container 102 used to transport goods or other articles. The non-intrusive container inspection system 100 comprises a charged particle accelerator 104 (sometimes also referred to herein as “accelerator 104”), a conversion target 106, and a collimator 108 that in combination form an accelerator subsystem 105. The charged particle accelerator 104, in the first exemplary embodiment, comprises a pulse-type, multi-energy, linear electron accelerator that is operable to continuously produce, or emit, a pulsed beam of accelerated electrons 110 including a first plurality of pulses of accelerated electrons 112 having a first energy level and a second plurality of pulses of accelerated electrons 114 having a second energy level different from the first energy level (see FIG. 4). Generally, the first and second energy levels are considered to be in the high energy range for pulses of electrons produced by an electron particle accelerator, but have sufficient difference to enable their use in discriminating between the materials of items present in a container 102. The individual pulses 112 of accelerated electrons of the first plurality of pulses 112 and the individual pulses 114 of the second plurality of pulses 114 are continuously emitted such that the pulsed beam of accelerated electrons 110 includes successive pulses of accelerated electrons having energy levels that alternate between the first energy level and the second energy level. Thus, each pulse 112 of accelerated electrons of the first plurality of pulses of accelerated electrons 112 having a first energy level is preceded and followed in the pulsed beam of accelerated electrons 110 by a pulse 114 of the second plurality of pulses of accelerated electrons 114 having a second energy level. Similarly, each pulse 114 of accelerated electrons of the second plurality of pulses of accelerated electrons 114 having a second energy level is preceded and followed in the pulsed beam of accelerated electrons 110 by a pulse 112 of the first plurality of pulses of accelerated electrons 112 having a first energy level.

Accelerator 104 has an output port that is connected, as illustrated in FIG. 1, to the conversion target 106 by a vacuum electron beam guide 116 that is adapted to guide, or direct, the pulsed beam of accelerated electrons 110 therein from the output port of accelerator 104 to the conversion target 106 during operation of the non-intrusive container inspection system 100. The conversion target 106 is operable to receive pulses of accelerated electrons 112, 114 of the pulsed beam of accelerated electrons 110 and to convert the received pulses of accelerated electrons 112, 114 into a pulsed bremsstrahlung beam 118 (e.g., a pulsed x-ray beam 118) that is output from the conversion target 106 toward collimator 108. Generally, the pulsed bremsstrahlung beam 118 includes alternating spectra corresponding respectively to the first and second energy levels of the alternating pulses of accelerated electrons 112, 114 of the pulsed beam of accelerated electrons 110 emitted by accelerator 104.

The collimator 108, generally, includes an elongate, narrow opening (e.g., a slot) through which a portion of the pulsed bremsstrahlung beam 118 passes to create pulsed bremsstrahlung beam 120 (e.g., a pulsed x-ray beam 120) having a beam shape suitable for container inspection. Typically, the pulsed bremsstrahlung beam 120 has a fan shape upon exiting the collimator 108. The collimator 108 is, according to the first exemplary embodiment, mounted to and/or integrated into a wall 122 separating an accelerator room 124 in which the accelerator 104 and conversion target 106 reside and an inspection room 126 through which containers 102 are moved relative to and exposed to the pulsed bremsstrahlung beam 120 exiting the collimator 108 in order to inspect their contents.

The non-intrusive container inspection system 100 additionally comprises a detector subsystem 150 having a detector array 152 with a plurality of detectors 154 that are operable to receive, as described in more detail herein, portions 156A, 156B, 156C, 156D of the pulsed bremsstrahlung beam 120 that, respectively: (i) pass through a container 102 (and the contents thereof) being inspected in the predominant direction 132 of travel or propagation of pulsed bremsstrahlung beam 120 and exit through a side wall thereof without being substantially deflected or scattered; (ii) are more substantially deflected or scattered by the container 102 or contents thereof in directions to a first side of the predominant direction 132 of travel or propagation of pulsed bremsstrahlung beam 120; (iii) are more substantially deflected or scattered by the container 102 or contents thereof in directions to a second side of the predominant direction 132 of travel of pulsed bremsstrahlung beam 120; and, (iv) pass through a container 102 (and the contents thereof) being inspected in the predominant direction 132 of travel or propagation of pulsed bremsstrahlung beam 120 and exit through a top, or roof, thereof without being substantially deflected or scattered. The detectors 154 are each adapted to produce electrical signals representative of the respective portions 156A, 156B, 156C, 156D of the pulsed bremsstrahlung beam 120 that they receive during operation of the non-intrusive container inspection system 100.

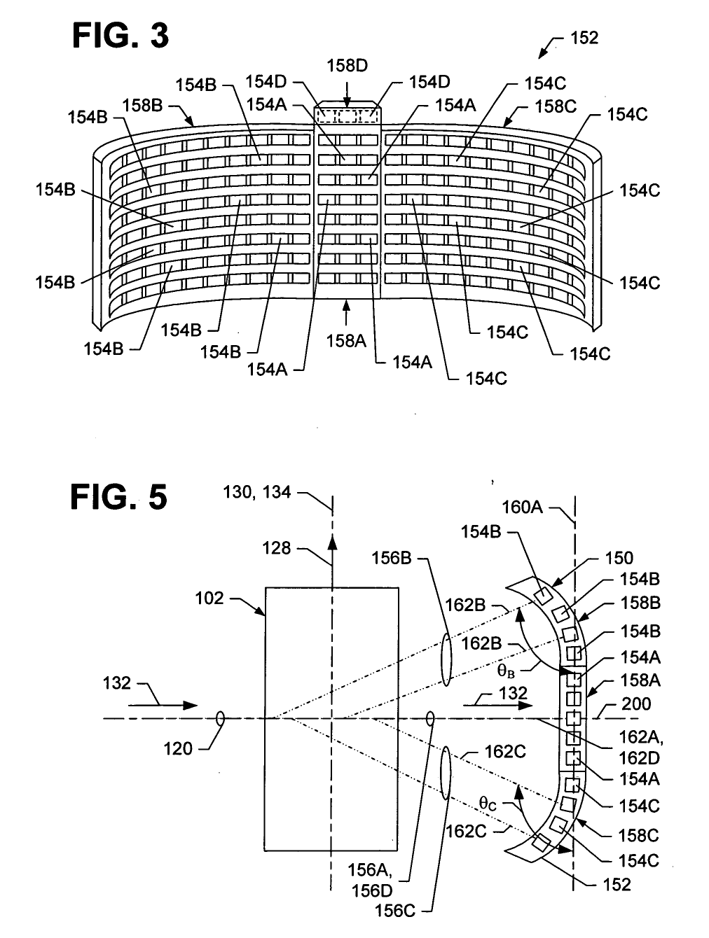

As displayed in FIGS. 1, 3, and 5, the plurality of detectors 154 of the detector array 152 are arranged in, generally, multiple sections 158A, 158B, 158C, 158D of detectors 154 such that the detectors 154A of the first section 158A are oriented in a plane 160A substantially perpendicular to the predominant direction 132 of travel of the pulsed bremsstrahlung beam 120 and substantially adjacent a side of a container 102 as the container 102 travels through the inspection room 126. The fourth section 158D of the detector array 152 includes detectors 154D oriented in a plane 160D substantially perpendicular to the plane 160A of the first section 158A of the detector array 152 (e.g., forming an “L” shape therewith) such that the fourth section 158D extends substantially adjacent a top, or roof, of a container 102 as the container 102 travels through the inspection room 126. The detectors 154A of the first section 158A and detectors 154D of the fourth section 158D, during operation of the non-intrusive container inspection system 100, receive portions 156A, 156D of the pulsed bremsstrahlung beam 120 that pass through the container 102 and the contents thereof without being substantially deflected or scattered. Notably, first section 158A receives portions 156A of the pulsed bremsstrahlung beam 120 that exit through a side of the container 102 being inspected, while fourth section 158D receives portions 156D of the pulsed bremsstrahlung beam 120 that pass through the top, or roof, of the container 102 being inspected. In order to better enable the reception of portions 156D of the pulsed bremsstrahlung beam 120 that pass through the top, or roof, of a container 102, some of the individual detectors 154D of the fourth section 158D of the detector array 152 are oriented in a direction substantially toward, or facing, the collimator 108 as opposed to being oriented in a direction perpendicular to the top, or roof, of a container 102 passing through the inspection room 126.

The detectors 154B of the second section 158B of the detector array 152 are arranged in a, generally, arcuate configuration such that, during operation of the non-intrusive container inspection system 100, they receive portions 156B of the pulsed bremsstrahlung beam 120. Similarly, the detectors 154C of the third section 158C of the detector array 152 are configured in a, generally, arcuate arrangement such that they receive portions 156C of the pulsed bremsstrahlung beam 120 during operation of the non-intrusive container inspection system 100. As illustrated more clearly in FIG. 5, the detectors 154B of the detector array's second section 158B are arranged to receive portions 156B of the pulsed bremsstrahlung beam 120 that are deflected or scattered at scatter angles, θ_{B}, measured relative to plane 160A. Similarly, the detectors 154C of the detector array's third section 158C are oriented to receive portions 156C of the pulsed bremsstrahlung beam 120 that are deflected or scattered at scatter angles, θ_{C}, measured relative to plane 160A. Notably, the angular measures of any two scatter angles, θ_{B} or θ_{C}, may or may not be the same.

The non-intrusive container inspection system 100 further comprises a controller 180 that is connected to the accelerator 104 and to the detector subsystem 150 via bi-directional communication links 182, 184, respectively. The controller 180, generally, comprises a computer system that is configured with appropriate hardware and software to control the operation of the accelerator 104 in order to cause (i) the accelerator 104 to generate, in appropriate synchronization with the speed of movement of a container 102 being scanned during inspection, the pulsed beam of accelerated electrons 110 having a rate of successive pulses of electrons having different energy levels and (ii) the generation of the pulsed bremsstrahlung beam 120 having successive pulses of multiple spectra corresponding to such different energy levels and directed at the container 102, that are necessary and appropriate to produce the volumes of data and frequency of data used to generate multi-plane and/or three dimensional images of the container's contents and to properly identify and/or discriminate between the materials of such contents. Such control is accomplished through operation of the hardware and execution of the software by a processing unit of the controller 180 to generate appropriate control signals that are communicated to the accelerator 104 through bi-directional communication link 182.

The controller 180 is also configured with appropriate hardware and software to control the operation of the detector subsystem 150 in order to collect and correlate data (including, but not limited to, data representative of all portions 156A, 156B, 156C, 156D of the pulsed bremsstrahlung beam 120 after they exit a container 102 being scanned during inspection) communicated from the detector subsystem 150 to the controller 180 over bi-directional communication link 184 in the form of electrical signals resulting from the scanning of the container 102 with the pulsed bremsstrahlung beam 120. Thus, execution of the software by a processing unit of the controller 180 enables and causes the controller 180 to (i) collect data received from the detector subsystem 150 during scanning of a container 102 and (ii) using additional data related to its control of accelerator 104 and related to the speed of the container's movement relative to the pulsed bremsstrahlung beam 120, to produce correlation data that correlates and/or associates respective portions of the collected data with the particular pulses of accelerated electrons 112, 114, with the corresponding different energy levels of such pulses 112, 114, and with the corresponding different spectra of pulsed bremsstrahlung beam 120, that caused such respective portions of the collected data to be produced by the detector subsystem 150. The controller 180, using additional data related to its control of accelerator 104 and related to the speed of the container's movement relative to the pulsed bremsstrahlung beam 120, also produces additional correlation data that correlates and/or associates respective portions of the collected data with planes 162A, 162D passing through particular locations along, and substantially perpendicular to, the container's longitudinal axis 134 and with planes 162B, 162C passing through the container 102 at various scatter angles, O. Additionally, the controller 180 is configured to communicate the collected data and correlation data to an imaging and material discrimination subsystem 190 described below.

The non-intrusive container inspection system 100 further comprises an imaging and material discrimination subsystem 190 that is connected to the controller 180 via bi-directional communication link 192. The bi-directional communication link 192 is adapted to communicate electrical signals (including, but not limited to, electrical signals representative of collected data corresponding to portions 156A, 156B, 156C, 156D of the pulsed bremsstrahlung beam 120 after they exit a container 102 and correlation data produced by the controller 180) between the controller 180 and the imaging and material discrimination subsystem 190. The imaging and material discrimination subsystem 190 comprises data communication equipment and computer systems configured with appropriate hardware and software, that are operable to receive and transform the collected data produced and output by the detectors 154 of the detector array 152 and the correlation data into multi-plane images (including, without limitation, three-dimensional images) of the contents of a scanned container 102 (using methods described herein) that it displays to inspection system operators or other personnel on a display device thereof. The imaging and material discrimination subsystem 190 is also operable to receive collected data produced and output by the detectors 154 of the detector array 152 and correlation data produced by the controller 180 and to calculate therefrom (using methods described herein) and to display to inspection system operators or other personnel on a display device thereof, the relative and respective densities and identities of the materials, or elements, present within the contents of a scanned container 102. Thus, the imaging and material discrimination subsystem 190 enables inspection system operators to visibly see the shapes of items present within a scanned container 102 (i.e., on a display device of the imaging and material discrimination subsystem 190) in multiple planes (and, in three-dimensions) and to be provided with the relative and respective densities of the materials, or elements, of such items. The software of the imaging and material discrimination subsystem 190 may also be configured to generate an audible alarm for hearing by inspection system operators when a particular material, or element, is detected in an item present in an inspected container 102.

More specifically, the portions 156A, 156B, 156C, 156D of the pulsed bremsstrahlung beam 120 that impinge on detectors 154A, 154B, 154C, 154D of the respective detector array sections 158A, 158B, 158C, 158D are oriented, generally, in planes 162A, 162B, 162C, 162D with planes 162A, 162D being substantially coplanar and planes 162B, 162C being at angles relative to planes 162A, 162D. By collecting and producing electrical signals representative of the forward-scattered portions 156B, 156C of the pulsed bremsstrahlung beam 120 for an entire container 102, the detector subsystem 150 provides the imaging and material discrimination subsystem 190, via controller 180, with collected data corresponding to portions of the container 102 and items therein, that lie not only in planes 162A, 162D, but also in planes 162B, 162C at the time of each pulse of the pulsed beam of accelerated electrons 110 and the pulsed bremsstrahlung beam 120 as the container 102 travels through the inspection room 126. The imaging and material discrimination subsystem 190 is adapted, using its software and such multi-plane data, to manipulate the data in order to produce and display multi-plane (including, without limitation, three dimensional) images of the items, or contents, of the scanned container 102. Further, by virtue of the pulsed bremsstrahlung beam 120 including consecutive pulses of bremsstrahlung having different spectra and its software, the imaging and material discrimination subsystem 190 is adapted to manipulate the data in order to calculate the densities of such items or contents. Notably, by being operable to collect and process such multi-plane data the non-intrusive container inspection system 100 makes it more difficult to pre-arrange the positions of multiple items within the container 102 in order to “hide”, render undetectable, or indistinguishable from other items, a particular item within the container 102 containing potentially hazardous or dangerous materials, elements, or substances.

During operation of the non-intrusive container inspection system 100, the accelerator 104 of the non-intrusive container inspection system 100 is appropriately controlled by the controller 180, via control signals communicated through bi-directional communication link 182, to produce the pulsed beam of accelerated electrons 110 directed at the conversion target 106 through vacuum electron beam guide 116. The pulsed beam of accelerated electrons 110 alternately includes pulses of accelerated electrons 112 having a first energy level and pulses of accelerated electrons 114 having a second energy level. Because the consecutive pulses of accelerated electrons 112, 114 directed at the conversion target 106 alternate between respective different energy levels, the pulsed bremsstrahlung beam 118 produced by and exiting from the conversion target 106 includes pulses of alternating first and second spectra corresponding to the first and second energy levels of the alternating pulses of accelerated electrons 112, 114. The pulsed bremsstrahlung beam 118 exits the conversion target 106 and is shaped (or, more specifically, the pulses of spectra of the pulsed bremsstrahlung beam 118 are shaped) by the collimator 108 to produce the pulsed bremsstrahlung beam 120. Similar to pulsed bremsstrahlung beam 118, pulsed bremsstrahlung beam 120 includes pulses of alternating first and second spectra corresponding to the first and second energy levels of the alternating pulses of accelerated electrons 112, 114.

The containers 102 are, generally, moved in a substantially linear direction of travel (e.g., indicated by arrow 128) along a longitudinal axis 130 of the inspection room 126 that is substantially perpendicular to the predominant direction of travel or propagation (e.g., indicated by arrow 132) of the pulsed bremsstrahlung beam 120 in order to scan the containers 102 and their contents. The relative motion between a container 102 and the pulsed bremsstrahlung beam 120 enables the non-intrusive container inspection system 100 to scan and collect data for the entire container 102 that is representative of items present therein. Because the accelerator 104 is operable to produce pulses of electrons and to alternate successive pulses of electrons between different energy levels at very high speeds relative to the speed of the container's movement and because, as a result, the pulsed bremsstrahlung beam 120 alternates between corresponding pulses of different spectra at very high speeds relative to the speed of the container's movement, the non-intrusive inspection system 100 is essentially adapted to produce and collect data associated with the multiple, different spectra at each spatial location, or point, within the container 102, thereby enabling the identification and/or discrimination of materials present in the container 102 at each such location. It should be noted that although the container 102 is moved relative to a stationary pulsed bremsstrahlung beam 120 in the exemplary embodiments described herein, the scope of the present invention includes similar non-intrusive container inspection systems in which a pulsed bremsstrahlung beam having multiple, different spectra is moved relative to a stationary container being inspected in order to collect data related to the contents of the container necessary and sufficient for the generation of multi-plane and/or three dimensional images of the container's contents and for properly identifying and/or discriminating between the materials of the container's contents.

After exiting the collimator 108, the pulsed bremsstrahlung beam 120 having multiple spectra travels or propagates substantially within plane 200 in a direction (e.g., indicated by arrow 132) predominantly perpendicular to the direction of travel of the container 102 (e.g., indicated by arrow 128) and impinges upon the container 102 as it is moved through the inspection room 126. Portions 156A, 156B, 156C, 156D of the pulsed bremsstrahlung beam 120, respectively: (i) pass through a container 102 (and the contents thereof) being inspected in the predominant direction 132 of travel or propagation of pulsed bremsstrahlurig beam 120 and exit through a side wall thereof without being substantially deflected or scattered; (ii) are more substantially deflected or scattered by the container 102 or contents thereof in directions to a first side of the predominant direction 132 of travel or propagation of pulsed bremsstrahlung beam 120; (iii) are more substantially deflected or scattered by the container 102 or contents thereof in directions to a second side of the predominant direction 132 of travel of pulsed bremsstrahlung beam 120; and, (iv) pass through a container 102 (and the contents thereof) being inspected in the predominant direction 132 of travel or propagation of pulsed bremsstrahlung beam 120 and exit through a top, or roof, thereof without being substantially deflected or scattered.

The portions 156A, 156B, 156C, 156D of the pulsed bremsstrahlung beam 120 then strike detectors 154A, 154B, 154C, 154D of the detector array 152. In response to receiving portions 156A, 156B, 156C, 156D of the pulsed bremsstrahlung beam 120, the detectors 154A, 154B, 154C, 154D produce and output data in the form electrical signals representative of and corresponding to the respective portions 156A, 156B, 156C, 156D of the pulsed bremsstrahlung beam 120 impinging thereon and the detector subsystem 150 then communicates such data to the controller 180, via bi-directional communication link 184, for collection thereby. The collected data corresponds to portions 156A, 156B, 156C, 156D of the pulsed bremsstrahlung beam 120 that either (i) pass through items within the container 102 without being scattered or (ii) are scattered and redirected by items within the container 102 so that they lie in respective planes 162A, 162B, 162C, 162D. Thus, the controller 180 collects data corresponding not only to planes that pass through the container 102 and the items therein substantially perpendicular to the direction 128 of travel of the container 102 during scanning, but also to planes that are at angles relative to the direction 128 of travel of the container 102 during scanning. Subsequently, the controller 180 produces correlation data associated with the collected data and communicates the collected data and correlation data to the imaging and material discrimination subsystem 190 where such data is stored for the entire container 102 and utilized, as described herein, for the generation of multi-plane images of the container's contents and for the identification and/or discrimination of the materials present in the container's contents.

Before proceeding further, it should be noted that the non-intrusive container inspection system 100 is operable to produce and collect data corresponding to each pulse (and, hence, to the energy level of each pulse) of the pulsed beam of accelerated electrons 110 and, therefore, to each pulse (and, hence, to the spectra of each pulse) of the pulsed bremsstrahlung beam 120. Depending at least upon the resolution desired for multi-plane images of a container's contents and/or at least upon the accuracy desired for the identification and/or discrimination of the materials of a container's contents (and, hence, upon the volume and frequency of collected data required for such resolution and/or accuracy), the controller 180 determines operation parameters that govern the operation of the non-intrusive container inspection system 100 and provides corresponding data and/or signals (including, without limitation, appropriate timing signals) at least to the accelerator subsystem 105 and the detector subsystem 150 to control their operation accordingly. Such operation parameters include, without limitation, the speed at which the container 102 must move relative to the pulsed bremsstrahlung beam 120, the rates at which the accelerator 104 must produce pulses of electrons and must alternate the successive pulses of the pulsed beam of accelerated electrons 110 between different energy levels (and, hence, the rates at which pulses of bremsstrahlung (e.g., x-rays) must be produced and at which successive pulses must alternate between different spectra corresponding to the different energy levels), and the rate at which the detector subsystem 150 must produce and provide output data to the controller 180 (and, hence, the rate at which the controller 180 must collect data) representative of received portions 156 of the pulsed bremsstrahlung beam 120.

It should be noted that although the foregoing description describes the controller 180 as producing data and/or signals that control the operation of the accelerator 104 to generate a pulsed beam of accelerated electrons 110 appropriate for the volume and frequency of data required for desired imaging and material discrimination, the controller 180 may additionally or alternatively produce data and/or signals that instruct the detector subsystem 150 to produce or not to produce output data representative of certain pulses of bremsstrahlung, or x-rays, of the pulsed bremsstrahlung beam 120. According to such a method, the accelerator 104 may be always operated continuously to produce a pulsed beam of accelerated electrons 110 having the same rate of successive pulses with multiple energy levels, but the volume and frequency of data collected by the controller 180 (and subsequently available for the generation of multi-plane images and/or for the identification and/or discrimination of materials) is determined by the controller 180 operating the detector subsystem 150 to produce output data at desired rates and/or frequencies. Further, the rate and/or frequency at which the detector subsystem 150 produces output data might be changed during scanning of a container 102 as desired in order to provide more or less data available for the subsequent generation of multi-plane images and/or identification and/or discrimination of materials in a particular portion of the container 102.

Upon the completion of the container's travel through the inspection room 126, the scanning thereof, and the receipt and storage of such data, the imaging and material discrimination subsystem 190 manipulates such data, using its software, to calculate the effective Z-numbers (or effective atomic numbers) and densities of the materials of such items or contents. The imaging and material discrimination subsystem 190 also, uses its software, to create multi-plane images (including, but not limited to, three-dimensional images) corresponding to the contents of, or items present in, the container 102.

In accordance with the first exemplary embodiment of the present invention, the software used by the imaging and material discrimination subsystem 190 to calculate the effective Z-numbers (or effective atomic) and densities for the items or contents of the scanned container 102 utilizes, implements, and is based upon equations, physics and mathematical analysis, and mathematical relationships associated with multi-energy material recognition as described herein. Generally, the determination of a value for the effective Z-number of an item present in a scanned container 102 is based upon the physical and mathematical relationships corresponding to the loss of intensity of a bremsstrahlung beam (e.g., an x-ray beam) as it travels through the various materials thereof. For each material traveled through, the bremsstrahlung, or x-ray, beam looses intensity with such loss of intensity being a function of (1) the effective Z-number (e.g., effective atomic number or composition) of the material, (2) the energy of the beam, and (3) the thickness of the material. Thus, if a bremsstrahlung, or x-ray, beam having pulses of multiple energies (or, for that matter, multiple bremsstrahlung, or x-ray, beams each having pulses of a single energy different than that of the pulses of the other beams) is directed through a number of materials and the beam's loss of intensity is measured at each energy, it is possible to solve certain mathematical relationships, or equations, in order to determine the effective Z-numbers and thicknesses of each material encountered by the beam.

If, for the sake of simplicity and descriptive purposes, consideration is given to the determination of the effective Z-number and thickness of a single material through which a bremsstrahlung, or x-ray, beam travels, the final intensity, I (MeV), of the beam emerging from the material may be computed by:
I(Iₒ,μ,t)=Iₒe^{-μt}
where Iₒ (MeV) corresponds to the intensity of the beam prior to entering the material, μ (cm²/g or cm⁻¹) corresponds to the material's coefficient of attenuation (described in more detail below), and t corresponds to the material's thickness. Since the material's coefficient of attenuation is dependent upon the material's effective Z-number, Z, and the energy, E_{ac} (Joules), of the bremsstrahlung or x-rays, the final intensity of the beam emerging from the material may be computed by:
I(Iₒ,Z,E_{ac},t)=Iₒe^{-μ(Z,Eac)t}.
Based on this relationship, a system of two equations and two unknowns may be obtained from two final intensities, two initial intensities, and the two energies that produced them. The system of two equations may then be solved to determine the material's thickness and effective Z-number.

Before proceeding further, it should be noted that the loss of intensity of a bremsstrahlung, or x-ray, beam traveling through a material results from, among other things, collisions of the beam with the material's atoms. The loss of intensity due to such collisions is mathematically related to the material's coefficient of attenuation, μ. Physically, the material's coefficient of attenuation, μ, is a function of photon cross section, σ, which is the sum of four properties of the material: (1) photoelectric cross section, σ_{τ}, (2) coherent scattering cross section, σ_{coh}, (3) incoherent (Compton) scattering, ac, and (4) pair production cross section, σ_{κ}.

The photon cross section of a particle is an expression of the probability that an incident particle will strike it. As such, photon cross section is strongly related to the total area of a material and the “radius” of the particles within the material. Typically, the photon cross section, σ, represents the cross-sectional area of a single atom, and consequently, the photon cross section is expressed in units of cm²/atom. Frequently, however, the photon cross section is expressed in units of “barns” instead of cm², with one barn=10⁻²⁴ cm².

At the quantum level, the four factors of photon cross section described above, each of which is a function of bremsstrahlung (or x-ray) energy, E, and effective Z-number, comprise terms or operands when computing the photon cross section. Thus, the photon cross section may be expressed as:
σ(Z,E)=σ_{τ}(Z,E)+σ_{coh}(Z,E)+σ_{c}(Z,E)+σ_{κ}(Z,E).
It should be noted that although each term of the above equation may be approximated using the relationships described below, large repositories of known photon cross section data exist for many different materials and may be utilized in lieu of such approximations. Interestingly, in the above equation for photon cross section, the photoelectric cross section, σ_{τ}, term dominates at lower bremsstrahlung, or x-ray, energies (e.g., <0.5 MeV). At higher bremsstrahlung, or x-ray, energies (e.g., >5 MeV), the pair production cross section, σ_{κ}, term dominates. At intermediate bremsstrahlung, or x-ray, energies (e.g., >0.5 MeV and <5 MeV), the coherent scattering cross section, σ_{coh}, and incoherent (Compton) scattering, ac, terms dominant the equation. Consequently, material recognition and effective Z-number determination techniques vary with the energy level of the pulses of the utilized bremsstrahlung, or x-ray, beam.

The photoelectric effect upon photon cross section, σ, results from an x-ray/atom collision in which the incident photon's energy is higher than the binding energy of some electron in the atom of the material. In such a collision, the incident photon of the bremsstrahlung, or x-ray, beam is absorbed and in its place, several fluorescent photons and one electron are ejected, thereby ionizing the atom. Naturally, any bremsstrahlung, or x-ray, that is absorbed does not exit the material and impinge upon a detector.

The photoelectric cross section property of a material, σ_{τ}, may be crudely approximated at low energies (e.g., several KeV to hundreds of KeV) by the following expression:
σ_{τ}(Z,E)≈10(Z⁵/E³).

The coherent scattering effect upon photon cross section, σ, results from an incident photon of the bremsstrahlung, or x-ray, beam making a glancing blow off of an atom of a material, thereby deflecting the bremsstrahlung, or x-ray, away from a detector. For bremsstrahlung, or x-ray, wavelengths less than the diameter of the scattering atoms, the coherent scattering cross section property of a material, σ_{coh}, may be approximated as follows:
σ_{coh}(Z,E)≈8πrₑ²Z²(λ(4πaZ^{1/3}))²(4/5−(λ(8aZ^{1/3})))
where λ is determined by the relationship E=hc/λ, h is Planck's constant (6.626068×10⁻³⁴ m² kg/s), c is the speed of light (299,792,458 m/s), rₑ is the classical electron radius (2.817940285×10⁻¹⁵ m), and a=0.885.

The incoherent (Compton) scattering effect upon photon cross section, σ, results from an incident photon of the bremsstrahlung, or x-ray, beam knocking out a loosely bound electron of an atom of a material and undergoing a direction change (and energy loss) in the process. Since the direction of the incident photon is changed, it will not impinge upon a detector. The incoherent (Compton) scattering property of a material, σ_{c}, may be approximated by the following relationship for bremsstrahlung, or x-ray, beams having energy levels in the medium range:
σ_{c}(Z,E)≈0.665Z.
Notably, the above approximation of the incoherent (Compton) scattering property, σ_{c}, is not substantially effected by the energy of the bremsstrahlung, or x-ray, beam and, thus, the approximation does not include energy as an operand.

The pair production cross section effect upon photon cross section, σ, at relativistic photon energies (E>2mₑc²—where mₑ represents the mass of an electron (e.g., 9.10938188×10⁻³ kg)) results from an incident photon of the bremsstrahlung, or x-ray, beam impacting an atom of a material and being “consumed” entirely, thereby producing an electron-positron pair. Thus, for relativistic photon energies, the pair production cross section property of a material, σ_{κ}, may be approximated proportionally as:
σ_{κ}(Z,E)∝Z² ln(E−2mₑc²).
At very high energies, E, the pair production cross section property of a material, σ_{κ}, is effectively constant.

As briefly described above, the total (linear) coefficient of attenuation, μₜₒₜ, for a particular material is physically a function of photon cross section, σ, which is calculated as the sum of the (1) photoelectric cross section, σ_{τ}, (2) coherent scattering cross section, σ_{coh}, (3) incoherent (Compton) scattering, σ_{c}, and (4) pair production cross section, σ_{κ}. Because the photon cross section, σ, depends on the effective Z-number and the energy, E_{ac}, of the bremsstrahlung or x-ray beam, the total (linear) coefficient of attenuation, μₜₒₜ, for a particular material is also a function of the effective Z-number and the energy, E_{ac}, of the bremsstrahlung or x-ray beam and may be calculated using the following equation:
μₜₒₜ(E_{ac},Z)=σ(Z,E_{ac})×ρ×N_{A}/A
where μₜₒₜ is measured in cm⁻¹, ρ is the volume density (g/cm³) for an atom of the material, N_{A} is Avogadro's number (6.02252×10²³ atom/mole), and A is the atomic mass (g/mole) for the material. Alternatively, the total (linear) coefficient of attenuation, μₜₒₜ, may be calculated in cm²/g as follows:
μₜₒₜ(E_{ac},Z)=σ(Z,E_{ac})×N_{A}/A.
It should be noted that as with photon cross section data, large repositories of pre-computed coefficients of attenuation exist for many materials and energy ranges. Thus, although the total (linear) coefficient of attenuation, μₜₒₜ, may be calculated or approximated using the above equations, it may be desirable to use a pre-computed value therefor obtained from such a repository.

With regard to the thickness, t, of a single material through which a bremsstrahlung, or x-ray, beam travels, if the material's length, L, with respect to the direction of travel of the bremsstrahlung, or x-ray, beam is L cm, then t=L. However, if not, the thickness, t, of a single material may be alternatively defined in g/cm² in terms of the material's length, L (cm), and the material's density, ρ (g/cm³), as follows:
t=L×ρ.

As also briefly described above, a determination of the effective Z-number and thickness of a single material through which a bremsstrahlung, or x-ray, beam travels may be made using a bremsstrahlung, or x-ray, beam having pulses of multiple energies (or, for that matter, multiple bremsstrahlung, or x-ray, beams each having pulses of a single energy different than that of the pulses of the other beams) that is directed through the material and measuring the beam's loss of intensity at each energy. Viewed slightly differently, if a bremsstrahlung, or x-ray, beam having alternating pulses of multiple energies (e.g., E_{LO} and E_{HI}) and correspondingly alternating intensities (e.g., I_{LOi} and I_{HIi}) is directed through a single material and at a plurality of detectors, the corresponding final intensities (e.g., I_{LO} and I_{HI}) are measurable by the plurality of detectors. Then, the effective Z-number and thickness, t, of the material are determinable using the following system of equations:
I_{LO}=I_{LOi}e^{μtot(E}^{_{LO}}^{,Z)t}
I_{HI}=I_{HIi}e^{μtot(E}^{_{HI}}^{,Z)t}
From these equations, the following equation is obtained:
ln(I_{LO}/I_{LOi})/ln(I_{HI}/I_{HIi})=μₜₒₜ(E_{LO},Z)/μₜₒₜ(E_{HI},Z).
Consequently, the effective Z-number of the material, Z, is obtained by minimizing the following function, F:
F(Z)=(ln(I_{LO}/I_{LOi})/ln(I_{HI}/I_{HIi})−μₜₒₜ(E_{LO},Z)/μₜₒₜ(E_{HI},Z))².
Using the effective Z-number of the material, Z, the thickness, t, of the material is then determined by backsolving either of the following equations:
t=−ln(I_{LO}/I_{LOi})/μₜₒₜ(E_{LO},Z)
t=−ln(I_{HI}/I_{HIi})/μₜₒₜ(E_{HI},Z)

It should be noted that the above-described method of determining the effective Z-number and thickness, t, of a material applies only to a single material. If, however, two or more materials were placed in the plane of the bremsstrahlung, or x-ray, beam as is typically encountered with a container 102, the materials would be recognized as a material of a single element and of a single thickness. In order to determine the Z-numbers and thicknesses for each material placed in the plane of the bremsstrahlung, or x-ray, beam, it is necessary to first determine the minimum number of scanning energies required to differentiate m different kinds of material. If m layers of different materials are present in the plane of a bremsstrahlung, or x-ray, beam having pulses at multiple scanning energies and if Zᵢ and tᵢ are, respectively, the atomic number and thickness of the ith material, then the final intensities of the pulses striking detectors of a detector subsystem may be computed by:
I(I₀,{Zᵢ},E_{ac},{tᵢ})=I₀Π_{1≦i≦m}e^{-μ(Z,Eac)ti}
Using this equation, the minimum number of scanning energies required for determining the Z-numbers and thicknesses for each material placed in the plane of the bremsstrahlung, or x-ray, beam may be determined.

Once the minimum number of scanning energies has been determined, principles and equations of absorption edge-based recognition and of scattering resulting from photon-electron collisions may be used to ascertain the Z-numbers and thicknesses of the m different kinds of material placed in the plane of the bremsstrahlung, or x-ray, beam. An absorption edge is a discrete upward spike in the coefficient of attenuation when photon energies are near the binding energies of electrons in the shells of an atom of a material. When the photon energy crosses the binding energy threshold, there is a significantly higher chance that it will ionize the atom. Note that because absorption edges are a photoelectric phenomenon, the energy ranges at which this technique is applicable are in the relatively low photoelectric range.

If the final intensities of the pulses of a bremsstrahlung, or x-ray, beam striking or impinging upon detectors are measured over a range of photon energies, a sharp downward spike will exist at each absorption edge in a material. Because each element above 10 Z has a unique set of absorption edges, measuring final intensities at energies just above and just below these edge energies can yield every element in the path of the beam.

It should be also noted that photon scattering results from a photon-electron collision and that the energy and direction of the scattered photon may be ascertained by modeling the scattering energy and distribution. In order to construct such a model, it is assumed that the impinged upon electron is effectively stationary. If E_{γ} is the energy of an incident photon of a pulse of a bremsstrahlung, or x-ray, beam and if energy and momentum are to be conserved, the following constraints before and after the collision must be obeyed:
E_{γ}+mₑc²=E′_{γ}+√(mₑ²c⁴+pₑ²c²)
0=p′_{γ} sin θ_{γ}+p′ₑ sin θₑ
E_{γ}/c=p′_{γ} cos θ_{γ}+p′ₑ cos θₑ
where E′_{γ} is the photon energy after collision, θ_{γ} is the scattering angle for the photon, θₑ is the scattering angle for the electron, p′_{γ} is the momentum of the photon after the collision, and p′ₑ is the momentum of the electron after the collision. Notably, for a photon of energy E, p=E/c and mₑc² is the relativistic rest mass energy of an electron.

From the above, when a photon of energy E_{γ} collides with an atom of a material, the polar scatter angle for the photon, θ, obeys the following constraint:
cos(θ)=1+(1/E_{γ}−1/E′_{γ})mₑc²
where in this case, E′_{γ} is the new energy of the photon. Reformulated, the final energy E′_{γ} as a function of E_{γ} and θ is:
E′_{γ}(E,θ)=E_{γ}[mₑc²/(mₑc²+E_{γ}(1−cos(θ))]

From this, it is possible to asymptotically bound the energy of a back-scattered photon, even one with “infinite” energy. At its maximal loss of energy, 180 degree (π radian) recoil:
lim_{Eγ→∞}E′_{γ}(E_{γ},π)≈0.255 MeV
And, for its maximum back-scatter energy, which happens at a 90 degree (π/2 radian) deflection:
lim_{Eγ→∞}E′_{γ}(E_{γ},π/2)=0.511 MeV
Consequently, for worst-case calculations, a maximum photon energy of 0.511 MeV can be used.

When the distribution of the scattering is considered, it becomes useful to speak of the ratio of (E_{γ}/E′_{γ}) after and before collision:
P(E_{γ},θ)=1/(1+E_{γ}/mₑc²(1−cos(θ)))
The above equation for final energy provides the final photon energy for any given scatter angle. It does not, however, provide the probability that a photon will scatter in any one direction. In order to determine such probability, use of the Klein-Nishina formula of the differential cross section is necessary:
dσ/dΩ=0.5rₑ²(P(E_{γ},θ)−P(E_{γ},θ)² sin ²θ+P(E_{γ},θ)³
where, as previously, rₑ is the classical electron radius. To understand the meaning of this formula, it is necessary to decompose cross section.

Suppose there is no interest in the probability that a photon scatters at all, but there is interest in the probability that a photon scatters into a particular region. There is some area around the electron that will scatter a colliding photon of a given energy into a particular region. The particular area around the electron is a partial cross section. If the space around an electron is divided into mutually exclusive regions, there is a partial cross section for each region. The sum of such partial cross sections equals the total cross section.

The Klein-Nishina formula provides a way of knowing how the total cross section changes as the size of the region, Ω, measured in steradians, changes. Here, dΩ=2π sin θ dθ. Therefore, the Klein-Nishina formula may be interpreted as “the probability that a photon of energy E_{γ} will scatter off an electron and into the region 2π sin θ dθ is dσ/dΩ.” With this formula, any possible region into which a photon may scatter can be converted to some part of Ω. Then, by integrating, the size of the cross section that will knock photons into that region is determined. Subsequently, the number of photons of a beam of photons that will be knocked into that region may be determined.

Continuing, the ratio of the logarithmic transparencies of a material at two energies, E_{γ1} and E_{γ2}, may be expressed as a function of the energies and Z-number:
δ(E_{γ1},E_{γ2},Z)=ln(T₁)/ln(T₂)=μₜₒₜ(E_{γ1},Z)/μₜₒₜ(E_{γ2},Z)
The transparencies are determined by directing a beam of bremsstrahlung, or x-rays, having pulses of respective energies E_{γ1} and E_{γ2} through a material and toward detectors. If δ, E_{γ1}, and E_{γ2} are known, it is possible to solve for the Z-number of the material. Transparency, T, is the inverse of absorption and is a function of photon energy E_{ac}, the material's thickness, t, and the material's Z-number as follows:
T(E_{ac},t,Z)=∫₀^{Eac}dP/dE_{γ}(E_{ac},E_{γ})e^{-μ(Eγ,Z)t}dE_{γ/∫}₀^{Eac}dP/dE_{γ}(E_{ac},E_{γ})dE_{γ}
Thus, transparency is the ratio of radiation intensity before and after the penetration of a barrier.

In the above equation for transparency,
dP/dE_{γ}(E_{ac},E_{γ})=dI/dE_{γ}(Eac,E_{γ})(1−e^{-μdet(Eγ)tdet)}μ^{en}_{det}(E_{γ})/μ_{det}(E_{γ})

Given two experimental transparency measurements, Tₑₓₚ₁ and Tₑₓₚ₂, of a material, the material's thickness and Z-number may be determined by minimizing (in λ-calculus notation):
λ(t,Z)√((T(E_{ac1},t,Z)−Tₑₓₚ₁)²+(T(E_{ac2},t,Z)−Tₑₓₚ₂)²)
Even though there may be multiple solutions to the above expression, a solution may be obtained by trying each discrete Z-number and then searching for the minimal material thickness, t. The transformation to absorption, α, from a transparency, T, is:
α(T)=(1−ln(T))

Using the above-described analysis, equations, expressions, methods, and software together with the above-described data collected and produced for the scanned container 102, the imaging and material discrimination subsystem 190 calculates effective Z-numbers at locations within the scanned container 102 and volumes for items present in the scanned container 102. The imaging and material discrimination subsystem 190 then utilizes the effective Z-numbers to calculate the densities of and to identify and discriminate between, the materials of the items present in the scanned container 102. Subsequently, the imaging and material discrimination subsystem 190 outputs, generally via a display device thereof, the densities and identities of the materials of the container's items to inspection system operators or other appropriate personnel. If the imaging and material discrimination subsystem 190 detects the presence of any harmful, or potential harmful, materials (including, without limitation, any explosives, nuclear materials, biological agents, chemical agents, or, generally, weapons of mass destruction), the imaging and material discrimination subsystem 190 alerts inspection system operators and/or other appropriate personnel by generating an appropriate alarm.

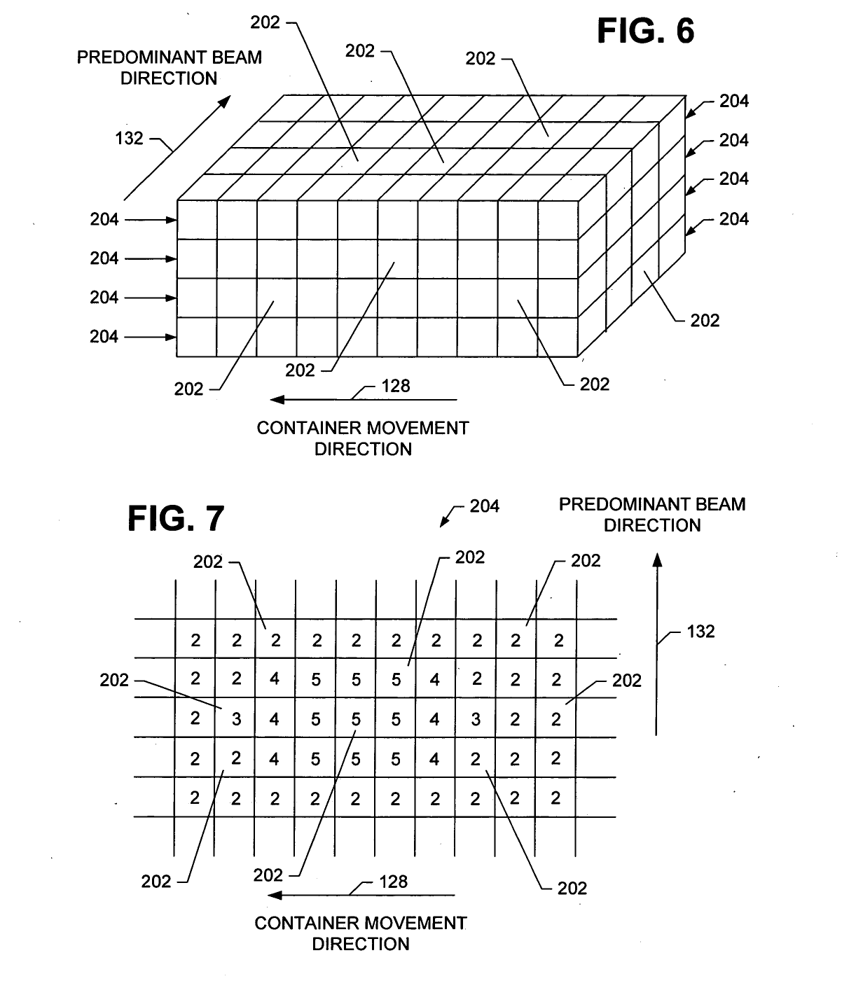

Further, using the above-described analysis, equations, expressions, methods, and software with the above-described data collected and produced for the scanned container 102 together with additional software that implements voxel rendering, the imaging and material discrimination subsystem 190 models the scanned container 102 as a plurality of voxels 202 (e.g., three-dimensional, volumetric elements), as displayed in FIG. 6, with voxels 202 extending in the direction 128 of the container's movement, in the predominant direction 132 of pulsed bremsstrahlung beam 120, and in the direction between the top and bottom of the container 102 (e.g., the vertical direction). The voxels 202 of the plurality of voxels 202 are arranged side-by-side in a plurality of planes 204 that are adjacent to one another.

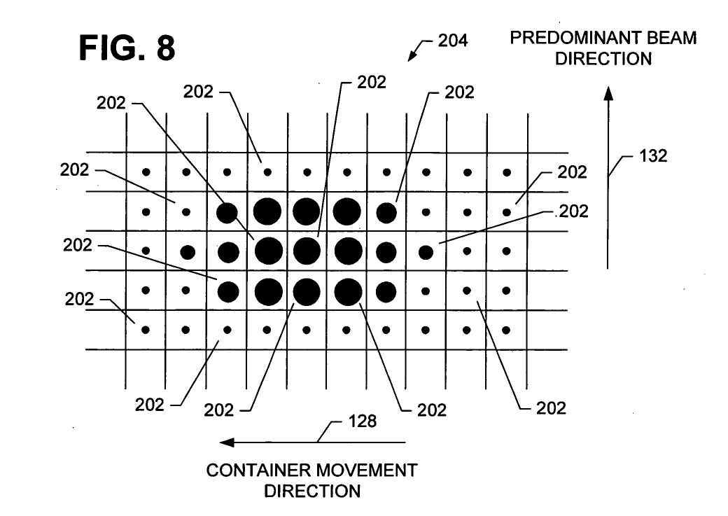

As illustrated in FIG. 7, the imaging and material discrimination subsystem 190 computes respective transparencies for each voxel 202 of each plane 204 and represents relative transparencies by assigning values corresponding to the computed transparencies using on a numerical scale, perhaps, having a range between the numbers 0 and 5. Generally, the number “0” corresponds to maximum transparency and the number “5” corresponds to minimum transparency. Then, the software of the imaging and material discrimination subsystem 190 creates multi-plane (and, most often, three-dimensional) images of the container 102 and its contents by visually rendering each voxel 202 of each plane 204, as seen in FIG. 8, using the collected data, produced correlation data, computed transparencies, and assigned values. In FIG. 8, the smaller circles represent voxels 202 having maximum transparency and the larger circles represent voxels 202 having minimum transparency. Collectively, when displayed on a display device of the imaging and material discrimination subsystem 190, the so rendered voxels 202 and planes 204 of voxels 202 provide a visual representation of the container 102 and its contents that may be viewed from a variety of operator-selectable directions.

It should be understood that the scope of the present invention encompasses other systems, including apparatuses and methods, for inspecting or scanning a container 102 that utilize one or more beam(s) of bremsstrahlung (e.g., x-rays) impinging on the container 102 that may each have one or more different spectra. Such spectra may or may not alternate in successive pulses of bremsstrahlung. It should also be understood that the scope of the present invention encompasses other systems, including apparatuses and methods, for inspecting or scanning a container 102 that include one or more particle accelerator(s) and that include one or more beam(s) of bremsstrahlung impinging on the container 102 from the same or different directions. Additionally, it should be understood that the scope of the present invention encompasses other systems, including apparatuses and methods, for identifying and/or discriminating between the materials present in items of a container 102 and for visually rendering an entire container 102 and the contents thereof, based upon data collected from the exposure of a container 102 to a beam of bremsstrahlung.

FIG. 9 displays a top plan, schematic view of a detector array 152′ of a non-intrusive container inspection system 100′, in accordance with a second exemplary embodiment of the present invention, that is substantially similar to the non-intrusive container inspection system 100 of the first exemplary embodiment. In the first exemplary embodiment, the detector array 152 includes a plurality of detectors 154 that are arranged in sections 158A, 158B, 158C, 158D such that sections 158B, 158C have an arcuate shape when viewed in a top plan view. Similarly, in the second exemplary embodiment, the detector array 152′ includes a plurality of detectors 154′ that are arranged in sections 158A′, 158B′, 158C′, 158D′. However, sections 158B′ and 158C′, respectively, include detectors 154B′ and 154C′ that are configured in respective planes 160B′ and 160C′ (i.e., when viewed in a top plan view) to receive portions 156B′ and 156C′ of the pulsed bremsstrahlung beam 120′.

It should be understood that the scope of the present invention encompasses detector arrays having sections arranged in one or more configuration(s), and encompasses detector arrays having none, one, or multiple section(s) to one or both sides of the predominant direction of the pulsed bremsstrahlung beam.

It should be further understood that the scope of the present invention includes containers that not only include containers typically employed in the transportation industry, but also containers that comprise, for example and not limitation: containers used in air, water, land, rail or truck commerce, piggyback trailers, packages, boxes, suitcases, luggage, bags, and any other device, article, or apparatus that may be used to transport items therewithin.

Whereas the present invention has been described in detail above with respect to exemplary embodiments thereof, it should be understood that variations and modifications might be effected within the spirit and scope of the present invention, as described herein before and as defined in the appended claims.

What is claimed is:

1. A method for non-intrusively inspecting a container used for the transportation of an item therein, the method comprising the steps of:
scanning a container and an item therein with an x-ray beam;
producing first data representative of a first portion of the x-ray beam that passes through the container and the item therein absent scattering thereof;
producing second data representative of a second portion of the x-ray beam that is scattered forward by at least one of the container or the item therein; and
generating a visual image of the item based at least in part on the first data and second data.

2. The method of claim 1, wherein the step of generating comprises computing respective transparencies for volumetric sub-portions of the item using the first and second data.

3. The method of claim 2, wherein the step of generating further comprises assigning relative transparencies for volumetric sub-portions based at least in part on the computed respective transparencies and a numerical scale having a range of transparency values.

4. The method of claim 2, wherein the step of generating further comprises visually rendering the volumetric sub-portions of the item based at least in part on the respective transparencies of the volumetric sub-portions.

5. The method of claim 2, wherein the step of generating comprises modeling the item as multiple planes of volumetric sub-portions.

6. The method of claim 5, wherein the step of scanning comprises directing the x-ray beam at the container in a first direction and creating relative movement between the x-ray beam and the container in a second direction, and wherein each plane of the multiple planes extends in the first direction and in the second direction.

7. The method of claim 1, wherein the step of producing second data comprises receiving the second portion of the x-ray beam with a plurality of detectors dedicated for receiving the second portion of the x-ray beam.

8. The method of claim 7, wherein the plurality of detectors are arranged in an arcuate configuration.

9. The method of claim 7, wherein the plurality of detectors are arranged in a planar configuration.

10. The method of claim 7, wherein the step of producing first data comprises receiving the first portion of the x-ray beam with a plurality of detectors dedicated for receiving the first portion of the x-ray beam.

11. The method of claim 1, wherein the method further comprises a step of computing an effective Z-number for the item using the first and second data.

12. The method of claim 11, wherein the step of producing first data comprises producing a first data subset of the first data corresponding to first spectra of the x-ray beam and producing a second data subset of the first data corresponding to second spectra of the x-ray beam.

13. The method of claim 11, wherein the step of producing second data comprises producing a first data subset of the second data corresponding to first spectra of the x-ray beam and producing a second data subset of the second data corresponding to second spectra of the x-ray beam.

14. The method of claim 11, wherein the x-ray beam comprises first x-ray spectra and second x-ray spectra different from the first x-ray spectra.

15. The method of claim 14, wherein the first x-ray spectra corresponds to a first energy level and the second x-ray spectra corresponds to a second energy level different from the first energy level.

16. The method of claim 1, wherein the x-ray beam comprises a sole x-ray beam.

17. A system for non-intrusively inspecting a container used for the transportation of an item therein, said system comprising:
a device adapted for producing an x-ray beam directed at a container having an item therein;
a first plurality of detectors adapted for receiving a first portion of said x-ray beam that passes through said container and said item therein absent scattering thereof and for generating first data representative of said first portion of said x-ray beam;
a second plurality of detectors adapted for receiving a second portion of said x-ray beam that is scattered forward by at least one of said container or said item therein and for generating second data representative of said second portion of said x-ray beam; and
a computing device communicatively connected to said first and second pluralities of detectors, said computing device being adapted for receiving said first and second data from said first and second pluralities of detectors and for using said first data and said second data to produce a visual image of said item or to identify a material of said item.

18. The system of claim 17, wherein said computing device is adapted for using said first data and said second data to produce a visual image of said item by logically subdividing said item into a plurality of volumetric sub-portions and by visually rendering said plurality of volumetric sub-portions based at least in part on transparencies computed for said plurality volumetric sub-portions.

19. The system of claim 18, wherein said computing device is further adapted for using said first data and said second data to produce a visual image of said item by computing transparencies for said plurality of volumetric sub-portions based at least in part on said first and second data.

20. The system of claim 17, wherein said first portion of said x-ray beam lies substantially in a first plane and said second portion of said x-ray beam lies substantially in a second plane different from said first plane.

21. The system of claim 17, wherein said first plane and said second plane define an angle therebetween.

22. The system of claim 17, wherein said computing device is further adapted for using said first data and said second data to identify a material of said item by determining an effective Z-number for said item.

23. The system of claim 22, wherein said x-ray beam comprises first x-ray spectra corresponding to a first energy level and a second x-ray spectra corresponding to a second energy level different from said first energy level.

24. The system of claim 22, wherein said first portion of said x-ray beam comprises first x-ray spectra and second x-ray spectra, and wherein said first data is representative said first x-ray spectra and said second x-ray spectra.

25. The system of claim 22, wherein said second portion of said x-ray beam comprises first x-ray spectra and second x-ray spectra, and wherein said second data is representative said first x-ray spectra and said second x-ray spectra.

26. The system of claim 17, wherein said detectors of said second plurality of detectors are arranged in a substantially arcuate configuration.

27. The system of claim 17, wherein said detectors of said second plurality of detectors are arranged in a substantially planar configuration.

28. A method for non-intrusively inspecting a container used for the transportation of an item therein, the method comprising the steps of:
directing a plurality of x-ray pulses substantially in a first direction toward a container and an item therein;
creating relative movement between the plurality of x-ray pulses and the container;
collecting first data corresponding to a first portion of the plurality of x-ray pulses that exit the container substantially in the first direction;
collecting second data corresponding to a second portion of the plurality of x-ray pulses that exit the container in a second direction different from the first direction; and
using the first and second data to produce visual images of the item or to determine an effective Z-number for the item.

29. The method of claim 28, wherein the step of collecting first data comprises configuring a first plurality of detectors of a detector array in a first section thereof to receive the first portion of the plurality of x-ray pulses, and wherein the step of collecting second data comprises configuring a second plurality of detectors of a detector array in a second section thereof to receive the second portion of the plurality of x-ray pulses.

30. The method of claim 29, wherein the second section is substantially curved when viewed in top plan view.

31. The method of claim 29, wherein the second section is substantially planar.

32. The method of claim 31, wherein the first section is substantially planar, and the first section and second section define an angle therebetween.

33. The method of claim 29, wherein the second section adjoins the first section.

34. The method of claim 28, wherein the plurality of x-ray pulses comprises a first plurality of x-ray pulses having first spectra and a second plurality of x-ray pulses having second spectra different from the first spectra.

35. The method of claim 34, wherein the method further comprises a step of producing the plurality of x-ray pulses with a single charged particle accelerator.

36. The method of claim 34, wherein the first spectra corresponds to a first energy level and the second spectra corresponds to a second energy level different from the first energy level.

37. The method of claim 28, wherein the step of using comprises computing respective transparencies for volumetric sub-portions of the item based at least in part on the first and second data.

38. The method of claim 28, wherein the step of using comprises visually rendering volumetric sub-portions of the item based at least in part on respective transparencies determined for the volumetric sub-portions.

39. The method of claim 28, wherein the step of using comprises assigning relative transparencies for volumetric sub-portions of the item based at least in part on a numerical scale having a range of transparency values.

40. The method of claim 28, wherein the step of using comprises modeling the item as a plurality of volumetric sub-portions.
